(19) United States
(12) Patent Application Publication
(10) Pub. No.: US 2010/0141019 A1
(43) Pub. Date: Jun. 10, 2010

(54) WHEEL CONSTRUCTION

(75) Inventors: Daniel Honiball, Western Australia (AU); Petru Tinc, Western Australia (AU)

Correspondence Address: MERCHANT & GOULD PC, P.O. BOX 2903, MINNEAPOLIS, MN, 55402-0903, US

(73) Assignee: CROCODILE TECHNOLOGY (UK) LIMITED, WEST PERTH (AU)

(21) Appl. No.: 12/513,047

(22) PCT Filed: Oct. 31, 2007
(86) PCT No.: PCT/AU07/01663

§ 371 Date: Jan. 22, 2010

(30) Foreign Application Priority Data
Oct. 31, 2006 (AU) 2006906052

(51) Int. Cl. B60B 19/00; B60B 3/02; B60B 21/02; B23P 17/00

(52) U.S. Cl. 301/5.1; 301/63.103; 301/95.101; 29/894.322

(57) ABSTRACT

A wheel (11) having a wheel rim (13) and a centre portion configured as a central disc (15). A tyre (17) is mounted on the rim (13). The wheel rim (13) comprises a generally annular body (21) incorporating a rim well (25). The rim well (25) defines a radially inner portion (27) which presents a radially inner face (29). The radially inner face (29) is of an annular configuration centred about the axis of rotation of the wheel. The centre disc (15) comprises a generally circular plate (31) having an outer periphery (35). The plate (31) incorporates a centre hole (37) and circumferentially spaced mounting holes (39) for receiving wheel studs. The outer periphery (35) is of a diameter which allows the plate (31) to be snugly received within the confines of the annular face (29) of the rim (13).The annular inner face (29) of the rim (13) has an axial extent (in the direction of rotation of the wheel) which is significantly greater than the thickness of the plate (31). In this way, the plate (31) can be positioned within the confines of the annular inner face (29) at any one of a plurality of available positions. The plurality of available positions includes three positions identified by reference characters A, B and C. The plate (31) can be secured to the rim (13) at the selected available position by being welded thereto.

### FIELD OF THE INVENTION

This invention relates to a wheel construction.

The invention has been devised particularly, although not solely, as a wheel construction for a non-pneumatic tyre.

### BACKGROUND ART

There have been various proposals for non-pneumatic tyres of vehicles. Typically, such tyres comprise an annular body formed of elastomeric material such as rubber. There have also been various proposals for attachments of the annular body to a wheel rim, including moulding the annular body of a tyre on to the rim portion of the wheel or forming the annular body separately (either as a one-piece unit or in segments) and then releaseably fastening the annular body to the rim portion of the wheel.

There are various types of wheel construction, and wheel specifications can differ between vehicles. A typical wheel construction comprises a centre portion configured as a metal centre disc and a metal rim fixedly mounted on the centre disc by being welded thereto. Mounting holes are provided in the centre disc to receive wheel studs for mounting the wheel onto the vehicle. The specifications for the wheel, which can vary between vehicles, include the number and relative positions of the mounting holes, and also the lateral position of the centre portion of wheel relative to the rim portion.

Because of the various wheel specifications, it is usual to construct a range of available wheels in order to accommodate the various specifications. Where there is demand for various wheel specifications, there may be a need to carry an inventory containing wheels having the various specifications. This incurs costs. The problem can be exacerbated for wheels of the type having tyres moulded onto their rims, as further costs are associated with also carrying the moulded tyres in the inventory.

It is against this background, and the problems and difficulties associated therewith, that the present invention has been developed.

### DISCLOSURE OF THE INVENTION

According to a first aspect of the invention there is provided a wheel comprising a rim portion and a centre portion for supporting the rim portion, the centre portion being attachable to the rim portion at a selected one of a plurality of available positions, the available positions being disposed in a direction parallel to the axis of rotation of the wheel.

Preferably, the centre portion is adapted to be attached to the rim portion by welding.

Preferably the rim portion presents a radially inner surface at which the plurality of available positions are located.

Preferably, the radially inner surface comprises a generally annular surface, the central axis of which is coincident with the axis of rotation of the wheel.

Preferably, the centre portion is configured as a disc structure having an outer periphery dimensioned to be received within the confines of the radially inner periphery of the rim portion.

Preferably, the disc structure comprises a planar disc.

Preferably, the wheel supports a tyre moulded onto the wheel rim portion.

According to a second aspect of the invention there is provided a wheel rim comprising a radially inner portion defining a radially inner surface to which a centre portion can be attached at a selected one of a plurality of available positions extending in a direction parallel to the axis of rotation of the wheel rim.

Preferably, the radially inner surface comprises a generally annular surface, the central axis of which is coincident with the axis of rotation of the wheel rim.

According to a third aspect of the invention there is provided a tyre and wheel assembly comprising a wheel rim portion, a tyre mounted on the wheel rim, and a centre portion for supporting the rim portion, the centre portion being attachable to the rim portion at a selected one of a plurality of available positions, the available positions being disposed in a direction parallel to the axis of rotation of the wheel.

Preferably, the tyre is mounted on the wheel rim by being moulded thereon.

According to a fourth aspect of the invention there is provided a wheel rim and tyre assembly comprising a tyre mounted on a wheel rim, the wheel rim having a radially inner portion defining a radially inwardly facing annular surface to which a centre portion can be attached at a selected one of a plurality of available positions extending in a direction parallel to the axis of rotation of the wheel rim.

According to a fifth aspect of the invention there is provided a method of constructing a wheel, the method comprising providing a rim portion and a centre portion for supporting the rim portion, selecting one of a plurality of available positions disposed in a direction parallel to the axis of rotation of the wheel at which the centre portion can be attached to the rim portion, and attaching the centre portion to the rim portion at the selected position.

Preferably, the method comprises attaching the centre portion to the rim portion at the selected position by welding the two portions together.

### BRIEF DESCRIPTION OF THE DRAWINGS

The invention will be better understood by reference to the following description of one specific embodiment thereof as shown in the accompanying drawings in which:

FIG. 1 is a sectional perspective view of a wheel according to the embodiment with a tyre fitted thereon and with the centre disc of the wheel shown in one position relative to the wheel rim;

FIG. 2 is a fragmentary cross-sectional view of the arrangement shown in FIG. 1;

FIG. 3 is a view similar to FIG. 2, with the exception that two other available positions for the centre disc are also shown in phantom lines;

FIG. 4 is a view similar to FIG. 1, with the exception that the centre disc is shown at another available position relative to the wheel rim and two other available positions also being shown in phantom lines;

FIG. 5 is a fragmentary cross-sectional view of the arrangement shown in FIG. 4;

FIG. 6 is a sectional perspective view of the wheel rim; and

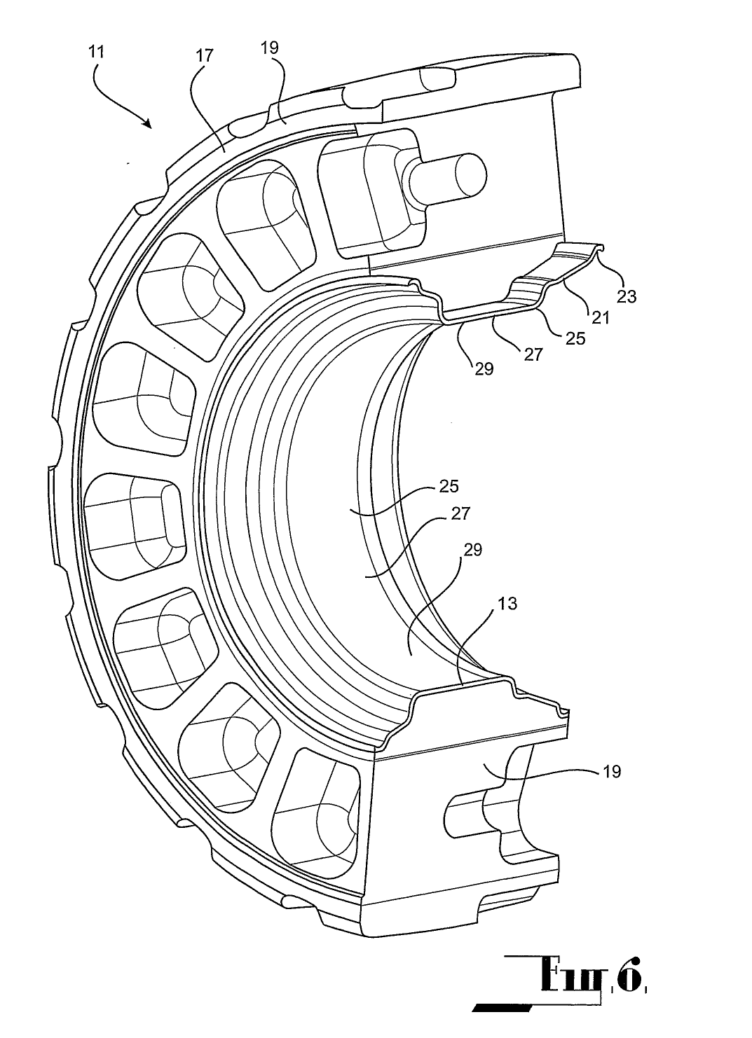

FIG. 7 is a fragmentary cross-sectional view of the wheel rim.

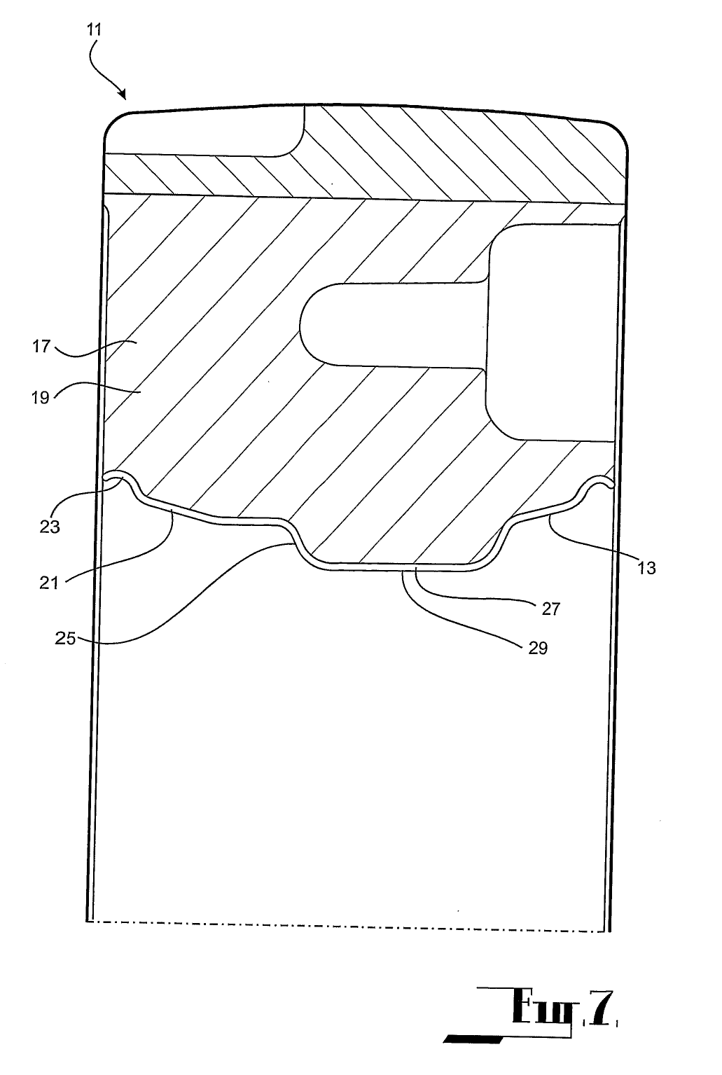

### BEST MODE(S) FOR CARRYING OUT THE INVENTION

The embodiment shown in the drawings is directed to a wheel 11 having a wheel rim 13 and a centre portion configured central disc 15. A tyre 17 is mounted on the rim 13 In this embodiment, the tyre 17 comprises en annular body 19 which is of one-piece construction and which is moulded onto the wheel rim 13. While the tyre 17 can be of any appropriate construction, a particularly suitable tyre is a tyre in accordance with the construction disclosed in the applicant's international application PCT/AU2007/000957, the contents of which are incorporated herein by way of reference.

The wheel rim 13 comprises a generally annular body 21 incorporating rim flanges 23 at opposed sides thereof and a rim well 25. The rim well 25 defines a radially inner portion 27 of the rim which presents a radially inner face 29. The radially inner face 29 is of an annular configuration centred about the axis of rotation of the wheel.

The centre disc 15 comprises a generally circular plate 31 formed of metal such as steel. The plate 31 has two opposed sides 33 and an outer periphery 35. The plate 31 incorporates a centre hole 37 and circumferentially spaced mounting holes 39 for receiving wheel studs.

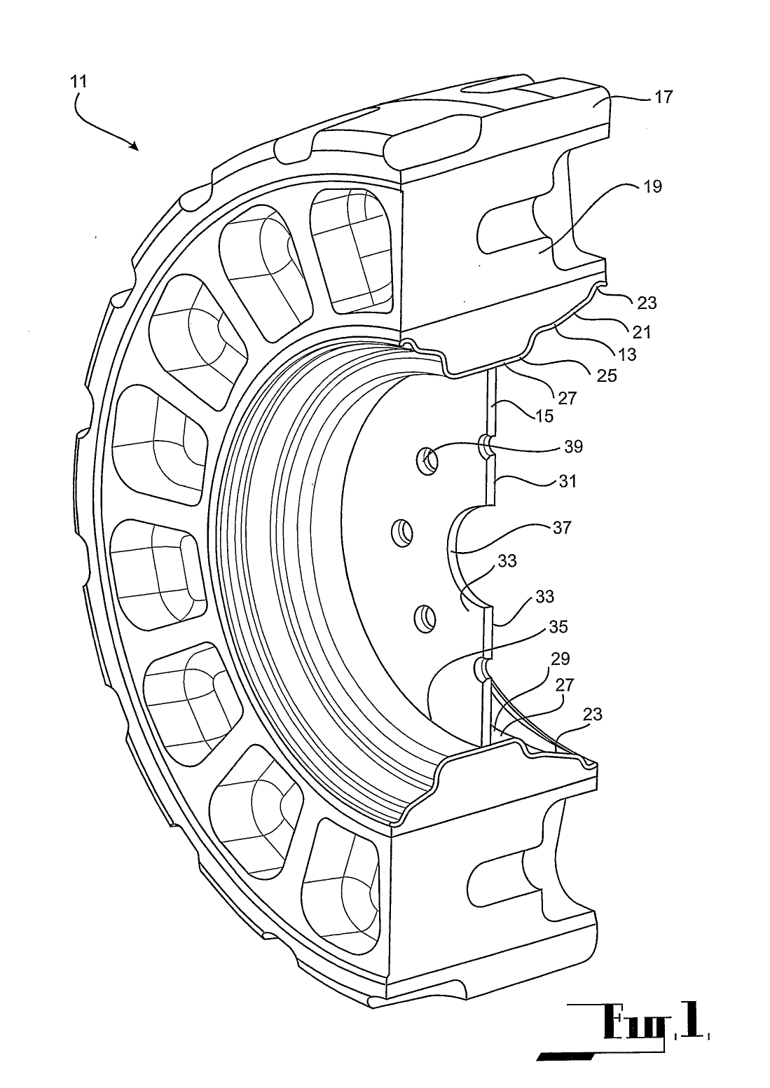

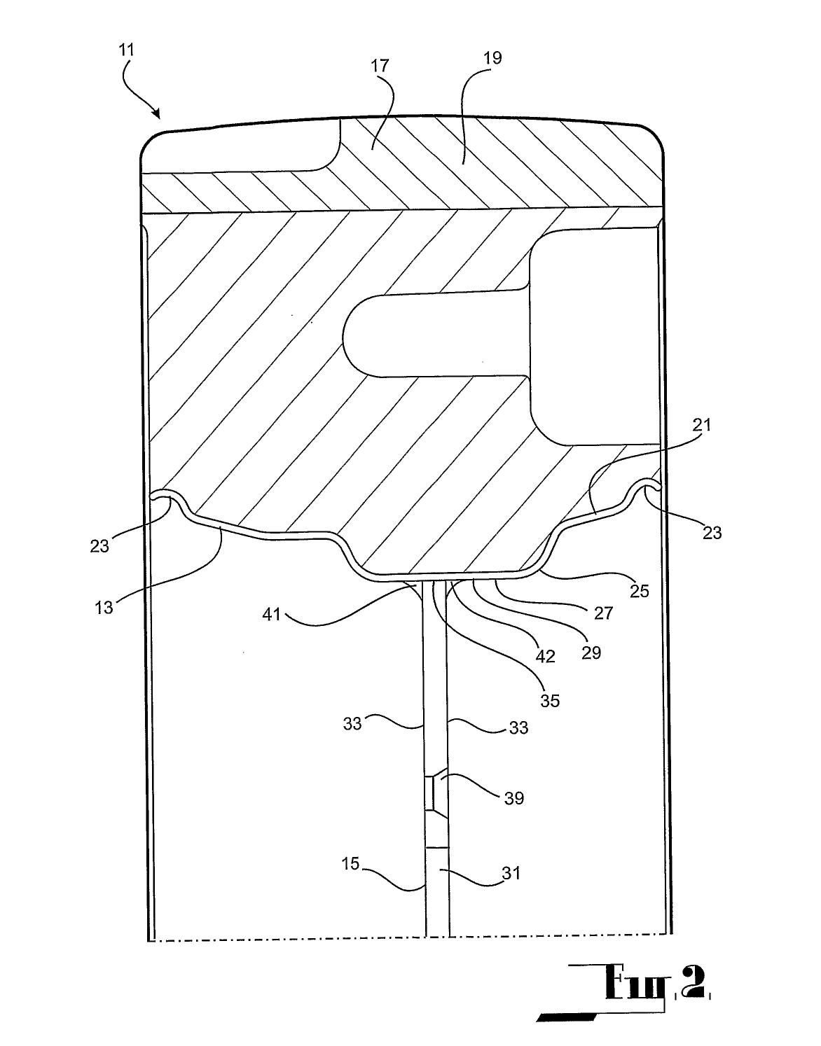

The outer periphery 35 is of a diameter which allows the plate 31 to be snugly received within the confines of the annular inner face 29 of the rim 13, as shown in FIGS. 1 to 5 of the drawings.

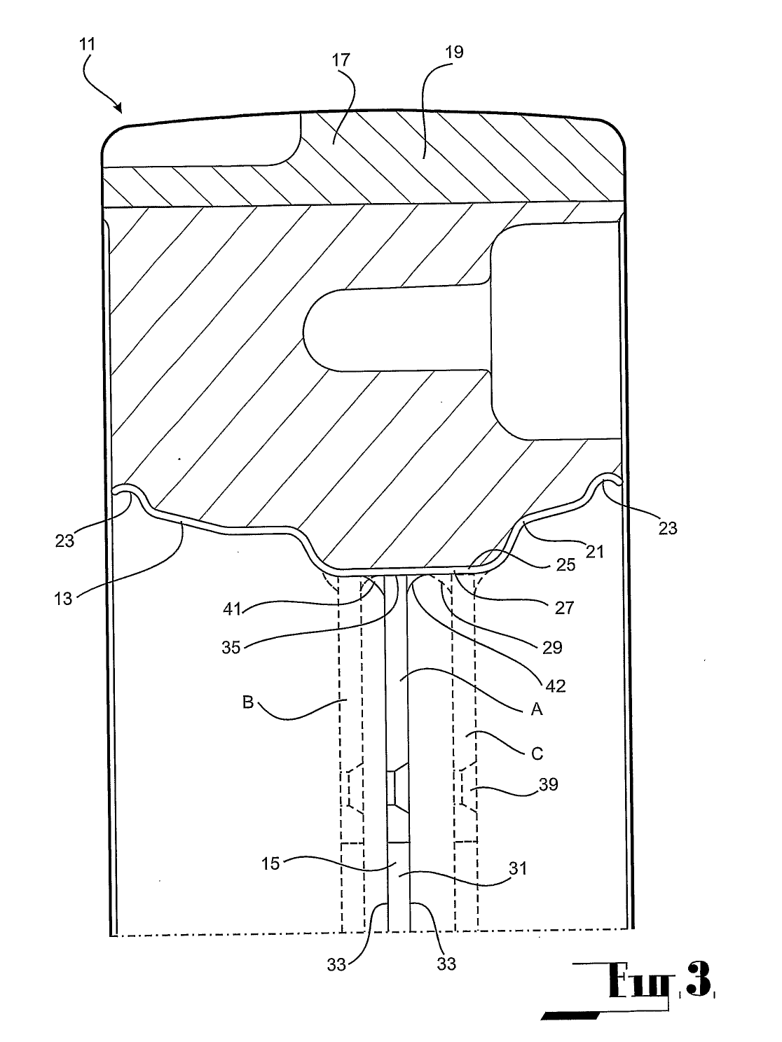

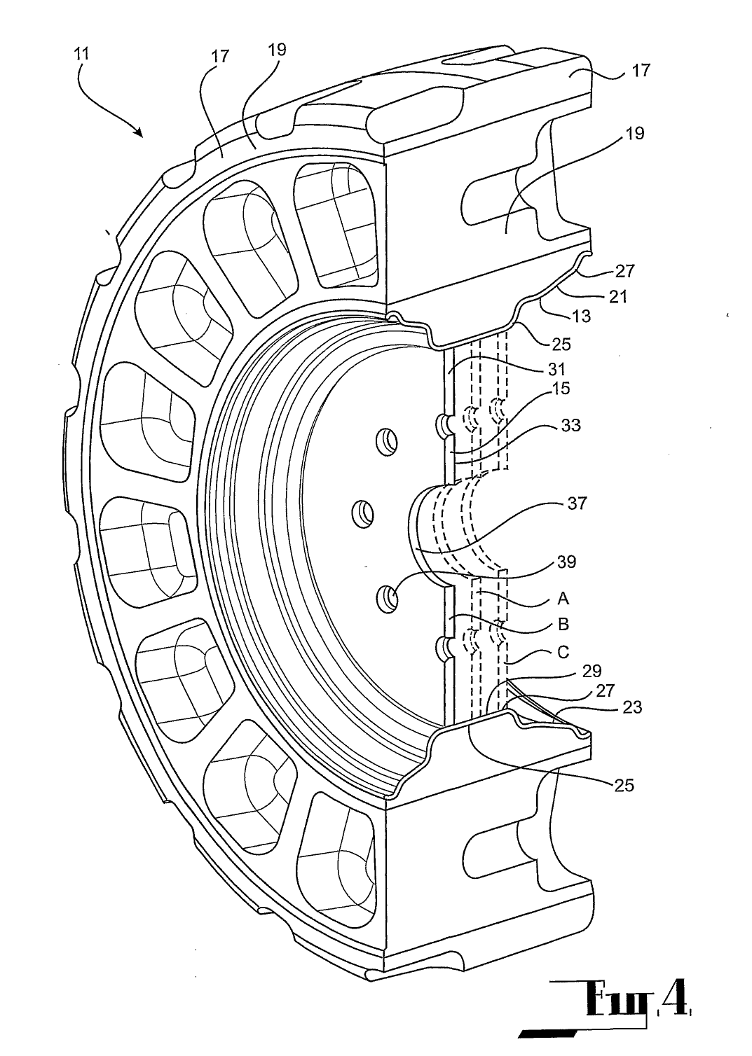

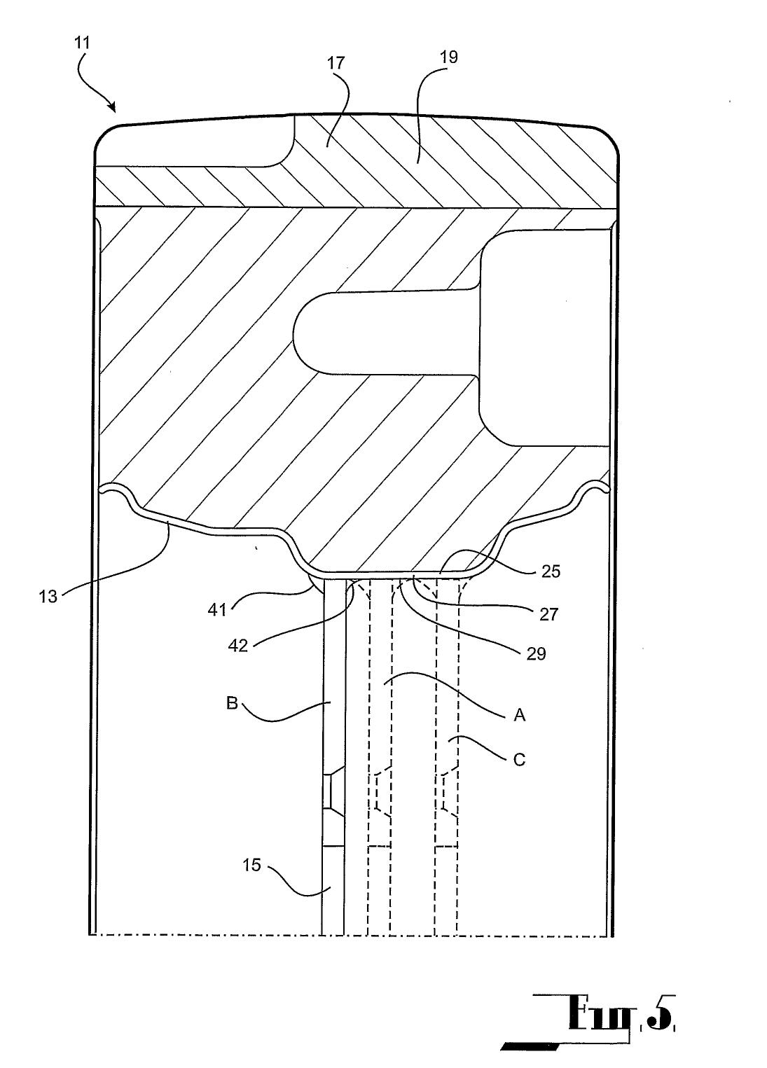

The annular inner face portion 29 of the rim 13 has an axial extent (in the direction of rotation of the wheel) which is significantly greater than the thickness of the plate 31 between the opposed sides 33 thereof. In this way, the plate 31 can be positioned within the confines of the annular inner face 29 at any one of a plurality of available positions. The plurality of available positions include the three positions illustrated in the drawings and identified by reference characters A, B and C. FIG. 3 illustrates the plate 31 at position A, with positions B and C being shown in phantom lines. FIGS. 4 and 5 illustrate the plate 31 at position B, with positions A and C being shown in phantom lines.

The plate 31 can be secured to the rim 13 at the selected available position by being welded thereto. In the arrangement shown, the plate 31 is attached to the rim 13 by welds 41, 42.

With this arrangement, the wheel 11 can be constructed in accordance with the specifications required for installation on a particular vehicle. Once the relative position of the centre portion 15 relative to the wheel rim 13 is known for a particular vehicle, the centre portion 15 can be fitted in position at the required location. In this way, it is not necessary for there to be a stock of assembled wheels suitable for a range of vehicles. Rather, it is merely necessary that there be a supply of common rims 13 and common centre portions 15. A wheel can then be constructed according to a required specification by fitting the centre portion 15 to the rim 13 at the required position.

From the foregoing, it is evident that the present embodiment provides an arrangement which allows a wheel to be constructed to fit a particular vehicle in a simple yet highly effective manner.

Throughout the specification, unless the context requires otherwise, the word “comprise” or variations such as “comprises” or “comprising”, will be understood to imply the inclusion of a stated integer or group of integers but not the exclusion of any other integer or group of integers.

1. A wheel comprising a rim portion and a centre portion for supporting the rim portion, the centre portion being attachable to the rim portion at a selected one of a plurality of available positions, the available positions being disposed in a direction parallel to the axis of rotation of the wheel, wherein the rim portion presents a radially inner annular surface at which the plurality of available positions are located, the annular surface having a centre axis coincident with the axis of rotation of the wheel, and wherein the centre portion defines an outer periphery dimensioned to be received within the radially inner annular surface of the rim portion at any one of the plurality of positions available therealong, the centre portion being adapted to be attached to the rim portion by welding.

2. A wheel according to claim 1 wherein the centre portion is configured as a disc structure.

3. A wheel according to claim 2 wherein the disc structure comprises a planar disc.

4. A wheel according to claim 1 further comprising a tyre moulded onto the wheel rim portion.

5. A wheel rim comprising a radially inner portion defining a radially inner annular surface to which a centre portion can be welded at a selected one of a plurality of available positions extending in a direction parallel to the axis of rotation of the wheel rim, the central axis of the radially inner annular surface being coincident with the axis of rotation of the wheel rim.

6. A tyre and wheel assembly comprising a wheel rim portion, a tyre mounted on the wheel rim, and a centre portion for supporting the rim portion, wherein the rim portion presents a radially inner annular surface at which the plurality of available positions are located, the annular surface having a centre axis coincident with the axis of rotation of the wheel, and wherein the centre portion defines an outer periphery dimensioned to be received within the radially inner annular surface of the rim portion at any one of the plurality positions available therealong, the centre portion being adapted to be attached to the rim portion by welding.

7. A tyre and wheel assembly according to claim 6 wherein the tyre is mounted on the wheel rim by being moulded thereon.

8. A wheel rim and tyre assembly comprising a tyre mounted on a wheel rim, the wheel rim having a radially inner portion defining a radially inwardly facing annular surface to which a centre portion can be attached by welding at a selected one of a plurality of available positions extending in a direction parallel to the axis of rotation of the wheel rim.

9. A wheel rim and tyre assembly according to claim 8 wherein the tyre is mounted on the wheel rim by being moulded thereon.

10. A method of constructing a wheel, the method comprising providing a rim portion and a centre portion for supporting the rim portion, selecting one of a plurality of available positions disposed in a direction parallel to the axis of rotation of the wheel at which the centre portion can be attached to the rim portion, and attaching the centre portion to the rim portion at the selected position, wherein the centre portion is attached to the rim portion at the selected position by welding the two portions together.

11. A wheel comprising a rim portion and a centre portion for supporting the rim portion, the centre portion being attachable to the rim portion at a selected one of a plurality of available positions, the available positions being disposed in a direction parallel to the axis of rotation of the wheel.

12. A wheel rim comprising a radially inner portion defining a radially inner surface to which a centre portion can be attached at a selected one of a plurality of available positions extending in a direction parallel to the axis of rotation of the wheel rim.

13. A tyre and wheel assembly comprising a wheel rim portion, a tyre mounted on the wheel rim, and a centre portion for supporting the rim portion, the centre portion being attachable to the rim portion at a selected one of a plurality of available positions, the available positions being disposed in a direction parallel to the axis of rotation of the wheel.

14. A wheel rim and tyre assembly comprising a tyre mounted on a wheel rim, the wheel rim having a radially inner portion defining a radially inwardly facing annular surface to which a centre portion can be attached at a selected one of a plurality of available positions extending in a direction parallel to the axis of rotation of the wheel rim.

15. A method of constructing a wheel, the method comprising providing a rim portion and a centre portion for supporting the rim portion, selecting one of a plurality of available positions disposed in a direction parallel to the axis of rotation of the wheel at which the centre portion can be attached to the rim portion, and attaching the centre portion to the rim portion at the selected position.

16.-20. (canceled)
